(19) United States
(12) Patent Application Publication
(10) Pub. No.: US 2025/0200518 A1
(43) Pub. Date: Jun. 19, 2025

(54) Business Process Management Device and Business Process Management Method

(71) Applicant: Hitachi, Ltd., Tokyo (JP)

(72) Inventor: Kiyotaka TAKAHASHI, Tokyo (JP)

(21) Appl. No.: 18/968,276

(22) Filed: Dec. 4, 2024

(30) Foreign Application Priority Data
Dec. 19, 2023 (JP) 2023-214206

(51) Int. Cl. G06Q 10/10; G06Q 10/067

(52) U.S. Cl. CPC G06Q 10/103; G06Q 10/067

(57) ABSTRACT

A business process management device acquires current business process data and new business process information, and identifies a similar business process candidate from an accumulated business process data group based on current business process information, the new business process information, and business process information. The business process management device identifies an insufficient work based on current work information and new work information. The business process management device selects a reuse target similar business process from the similar business process candidates, and identifies, from the selected reuse target similar business process, a work that can be applied to an insufficient work of a new business process as a reuse target.

### BACKGROUND OF THE INVENTION

### 1. Field of the Invention

The present invention relates to a business process management device and a business process management method.

### 2. Description of Related Art

Management of a business process is performed for an object of achieving target and improving efficiency of an organization through automation of a process and effective use of information by using a computer.

PTL 1 discloses a digital solution selection device (hereinafter, referred to as a “related device”) capable of quickly and accurately specifying a combination of appropriate digital solutions. The related device stores, in a storage device, information on a plurality of digital solutions indicating a target issue of each digital solution of the plurality of digital solutions, a digitalization maturity in a plurality of axes necessary for introduction of each digital solution, and an implementation digitalization maturity in the plurality of axes implemented by each digital solution.

The related device specifies a problem of interest of the organization, selects a final digital solution matching the problem of interest, sequentially selects one or more digital solutions from solution information in a reverse order to an introduction order from the final digital solution such that an implementation digitalization maturity in a plurality of axes of a digital solution immediately before the final digital solution in the introduction order is equal to or higher than a digitalization maturity in a plurality of axes of a digital solution immediately following the final digital solution, and specifies a combination of appropriate digital solutions based on the selection of the digital solutions in a digital solution set.

### CITATION LIST

### Patent Literature

PTL 1: JP2023-10246A

### SUMMARY OF THE INVENTION

In the related art, even when a business process which has been proposed to implement digital transformation (DX) through a customer conference is accumulated, it is not possible to reuse and effectively utilize the business process. In an environment of a customer, several solutions are often operated regardless of their own company and other companies, and growth and transformation from a baseline are required. Therefore, a new business process is generated (built) by improving the current business process. At this time, it is required to effectively utilize (reuse) the accumulated business process.

However, information related to a plurality of elements forming the business process is not prepared to be processed by a computer. Therefore, the reuse of the accumulated business process depends on human skills, such as the need to manually find parts that can be reused. In addition, since the business process is not managed by being divided into parts (elements) forming business processes, it is difficult to determine a reusable part. In the related device disclosed in PTL 1, the solution provided once cannot be reused in a work unit with finer granularity.

The invention is made to solve the above problems. That is, an object of the invention is to provide a business process management device and a business process management method that can effectively utilize an accumulated business process by identifying a part to be reused in a work unit for the accumulated business process.

In order to solve the above problem, a business process management device of the invention includes an information processing device configured to manage a business process including a sequence of a plurality of works. The information processing device includes a storage device that stores, for each of a plurality of business processes, an accumulated business process data group including business process information for describing a content of the business process, work information for describing a content of a work forming the business process, and data related to the business process. The information processing device: acquires current business process data, which includes current business process work information related to a current business process and a work forming the current business process and data related to the current business process, and new business process work information related to a new business process and a work forming the new business process, or project environment provision value information indicating a project environment and a provision value; and performs, based on the current business process work information and the new business process work information or the project environment provision value information, similar business process candidate identification of identifying, from the accumulated business process data group, one or more similar business process candidates which are the business process where the current business process and the new business process or the project environment provision value information match the project environment, reuse target similar business process selection of selecting a reuse target similar business process from the identified one or more similar business process candidates, and reuse target work identification of identifying, in a work unit, at least a part of works of the selected reuse target similar business process as a reuse target.

A business process management method of the invention is a business process management method using an information processing device that manages a business process including a sequence of a plurality of works. The information processing device includes a storage device that stores, for each of a plurality of business processes, an accumulated business process data group including business process information for describing a content of the business process, work information for describing a content of a work forming the business process, and data related to the business process. The business process management method includes: by the information processing device, acquiring current business process data, which includes current business process work information related to a current business process and a work forming the current business process and data related to the current business process, and new business process work information related to a new business process and a work forming the new business process, or project environment provision value information indicating a project environment and a provision value; and performing, based on the current business process work information and the new business process work information or the project environment provision value information, similar business process candidate identification of identifying, from the accumulated business process data group, one or more similar business process candidates which are the business process where the current business process and the new business process or the project environment provision value information match the project environment, reuse target similar business process selection of selecting a reuse target similar business process from the identified one or more similar business process candidates, and reuse target work identification of identifying, in a work unit, at least a part of works of the selected reuse target similar business process as a reuse target.

According to the invention, it is possible to effectively utilize an accumulated business process by identifying a part to be reused in a work unit for the accumulated business process. The effects described herein are not necessarily limited, and may be any effects described in the present disclosure.

### BRIEF DESCRIPTION OF THE DRAWINGS

FIG. 1 is a perspective view showing a configuration example of a business process management device according to a first embodiment of the invention.

FIG. 2 is a diagram showing a business process table.

FIG. 3 is a diagram showing a work table.

FIG. 4 is a diagram showing a design information table.

FIG. 5 is a diagram showing a result information table.

FIG. 6A is a diagram showing a usage example of the business process management device.

FIG. 6B is a diagram showing a usage example of the business process management device.

FIG. 6C is a diagram showing a usage example of the business process management device.

FIG. 6D is a diagram showing a usage example of the business process management device.

FIG. 7 is a flowchart showing a processing flow executed by a business process search and evaluation unit.

FIG. 8 is a flowchart showing a processing flow executed by a current business process input unit.

FIG. 9 is a flowchart showing a processing flow executed by a new business process input unit.

FIG. 10 is a flowchart showing a processing flow executed by the business process search and evaluation unit.

FIG. 11 is a flowchart showing a processing flow executed by the business process search and evaluation unit.

FIG. 12 is a flowchart showing a processing flow executed by the business process search and evaluation unit.

FIG. 13 is a flowchart showing a processing flow executed by the business process search and evaluation unit.

FIG. 14 is a flowchart showing a processing flow executed by the business process search and evaluation unit.

FIG. 15 is a flowchart showing a processing flow executed by the business process search and evaluation unit.

FIG. 16 is a flowchart showing a processing flow executed by the business process search and evaluation unit.

FIG. 17 is a flowchart showing a processing flow executed by the business process search and evaluation unit.

FIG. 18 is a flowchart showing a processing flow executed by the business process search and evaluation unit.

### DESCRIPTION OF EMBODIMENTS

Hereinafter, embodiments of the invention will be described with reference to the drawings. In the drawings of the embodiments, the same or corresponding parts may be denoted by the same reference numerals. In the following description, various types of information may be described by expressions such as “table” and “list”, but the various types of information may be expressed by other data structures. Further, when describing identification information, expressions such as “identifier” and “name” are used. The expressions can be replaced with one another, and other expressions may be used. Further, in the following description, although processing may be described using a functional block as a subject, the subject of the processing may be a CPU or a device instead of the functional block.

### First Embodiment

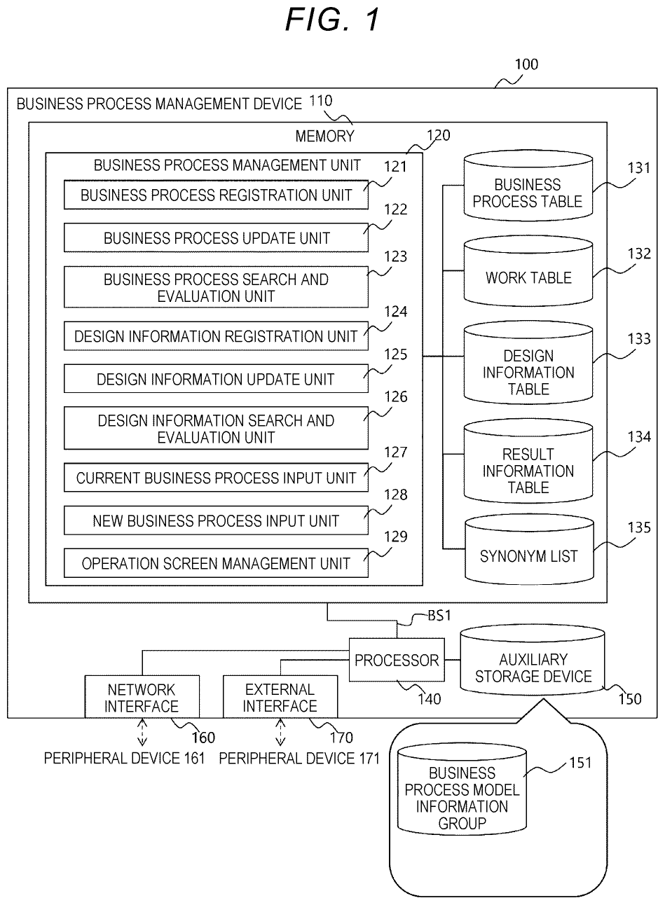

A business process management device 100 according to a first embodiment of the invention will be described. FIG. 1 is a diagram showing a configuration example of the business process management device 100 according to the first embodiment of the invention. As shown in FIG. 1, the business process management device 100 includes a memory 110, a processor 140, an auxiliary storage device 150, a network interface 160, and an external interface 170. These components are communicably connected to one another via a bus BS1.

A device including the memory 110, the processor 140, the auxiliary storage device 150, the network interface 160, the external interface 170, and the bus BS1 may be referred to as an “information processing device”. The information processing device may be a plurality of information processing devices or a virtual information processing device constructed on a cloud.

The memory 110 is a semiconductor storage device such as a random access memory (RAM), and temporarily stores a program loaded from the auxiliary storage device 150 to be executed by the processor 140 and necessary data.

The memory 110 includes a business process management unit 120 as a program. The business process management unit 120 includes a business process registration unit 121, a business process update unit 122, a business process search and evaluation unit 123, a design information registration unit 124, a design information update unit 125, a design information search and evaluation unit 126, a current business process input unit 127, a new business process input unit 128, and an operation screen management unit 129. These programs are, for example, loaded from the auxiliary storage device 150 into the memory 110 and executed by the processor 140, thereby implementing various functions.

The business process registration unit 121 registers (stores) information related to a business process in various tables and a business process model information group 151. The business process update unit 122 updates and deletes the information related to the business process stored in the various tables and the business process model information group 151. The business process search and evaluation unit 123 searches for and evaluates the business process. The design information registration unit 124 registers (stores) design information in a design information table 133. The design information table 133 may be referred to as “design information management information” for convenience. The design information search and evaluation unit 126 searches for and evaluates the design information. The current business process input unit 127 acquires information related to a current business process received from a user via a first peripheral device 161 or a second peripheral device 171. The new business process input unit 128 acquires information related to a new business process received from the user via the first peripheral device 161 or the second peripheral device 171. The operation screen management unit 129 performs display control of an operation screen which is a GUI screen to be output and displayed to the first peripheral device 161 or the second peripheral device 171.

The memory 110 further includes a business process table 131, a work table 132, the design information table 133, a result information table 134, and a synonym list 135. The business process table 131, the work table 132, the design information table 133, and the result information table 134 are used when a program is executed. These tables are stored in, for example, the auxiliary storage device 150, loaded from the auxiliary storage device 150 into the memory 110 and temporarily stored when the program is executed. Details of the business process table 131, the work table 132, the design information table 133, the result information table 134, and the synonym list 135 will be described later.

The processor 140 executes a program stored in the memory 110. For example, the processor 140 loads the program stored in the auxiliary storage device 150 into the memory 110. The processor 140 implements each function of the business process management unit 120 by executing the program loaded in the memory 110.

The auxiliary storage device 150 is a non-volatile storage device capable of reading and writing data. The auxiliary storage device 150 stores (holds) programs executed by the processor 140 and data used by the processor 140.

The auxiliary storage device 150 stores the business process model information group 151. The business process model information group 151 includes a plurality of business process models related to a plurality of business processes. The business process model is information indicating a plurality of works forming a business process, an order of the plurality of works, and data (for example, design information) used in the works. A model information identifier for identifying the business process models is assigned to each of the plurality of business process models.

The network interface 160 is an interface for connecting the business process management device 100 to a network (not shown). The business process management device 100 is connected to the first peripheral device 161 via the network. The first peripheral device 161 is a user terminal (for example, a personal computer (PC), a smartphone, a tablet, or the like) used by the user.

The external interface 170 is an interface for connecting the second peripheral device 171. The second peripheral device 171 is an operation device such as a keyboard and a mouse, a display, or the like.

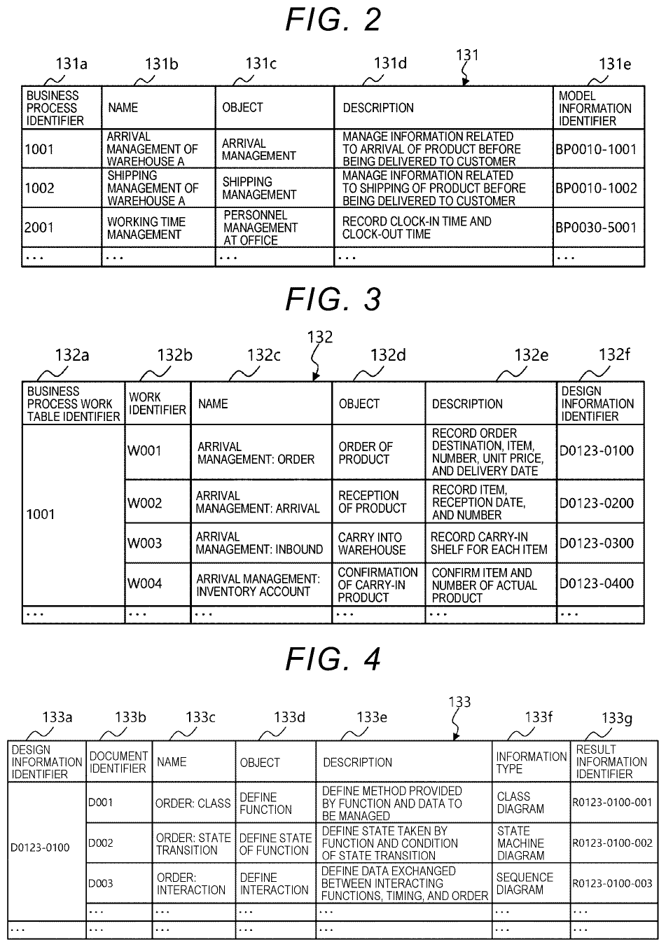

FIG. 2 is a diagram showing the business process table 131. As shown in FIG. 2, the business process table 131 includes a business process identifier 131a, a name 131b, an object 131c, a description 131d, and a model information identifier 131e as columns for storing information (values). In the business process table 131, information corresponding to each of columns related to business processes is associated with one another and stored as information (records) in row units.

Specifically, an identifier for identifying a business process is stored in the business process identifier 131a. The name 131b stores a name of the business process. The object 131c stores an object of the business process. The description 131d stores a description of the business process (business process description). The model information identifier 131e stores a model information identifier of a business process model corresponding to the business process. The business process table 131 may be referred to as “business process information” for convenience.

FIG. 3 is a diagram showing the work table 132. As shown in FIG. 3, the work table 132 includes a business process work table identifier 132a, a work identifier 132b, a name 132c, an object 132d, a description 132e, and a design information identifier 132f columns as for storing information (values). In the work table 132, information corresponding to each of columns related to works forming the business process is associated with one another and stored as information (records) in row units.

Specifically, the work table identifier 132a stores an identifier of the corresponding business process. The work identifier 132b stores an identifier for identifying a work forming the corresponding business process. The name 132c stores a name of the work. The object 132d stores an object of work. The description 132e stores a description (work description) related to the work. The design information identifier 132f stores an identifier for identifying design information corresponding to the work. The work table 132 may be referred to as “work information” for convenience.

FIG. 4 is a diagram showing the design information table 133. As shown in FIG. 4, the design information table 133 includes a design information identifier 133a, a document identifier 133b, a name 133c, an object 133d, a description 133e, an information type 133f, and a result information identifier 133g, as columns for storing information (values). In the design information table 133, information corresponding to each of columns related to design information such as software associated with a work is stored as information (records) in row units.

Specifically, the design information identifier 133a stores an identifier for identifying design information.

The document identifier 133b stores an identifier for identifying a document forming the corresponding design information. The name 133c stores a name of the corresponding document. The object 133d stores an object of the corresponding document. The description 133e stores a description of the corresponding document. The information type 133f stores a type of information on the corresponding document. The result information identifier 133g stores an identifier of result information corresponding to the document.

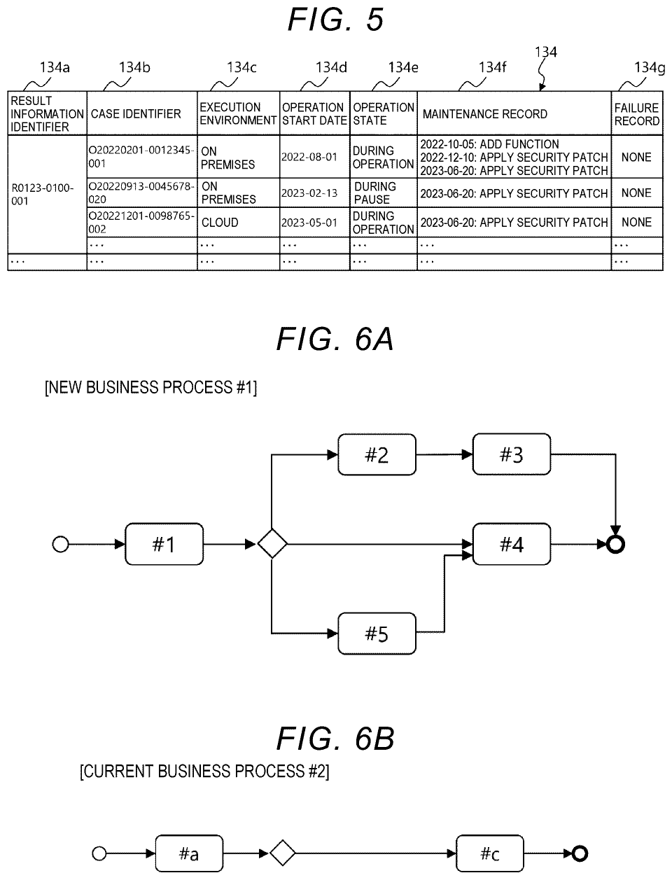

FIG. 5 is a diagram showing the result information table 134. As shown in FIG. 5, the result information table 134 includes a result information identifier 134a, a case identifier 134b, an execution environment 134c, an operation start date 134d, an operation state 134e, a maintenance record 134f, and a failure record 134g as columns for storing information (values). In the result information table 134, information corresponding to each of columns related to execution results of the software corresponding to the design information is stored. The result information table 134 may be referred to as “result management information”.

Specifically, the result information identifier 134a stores an identifier for identifying result information. The case identifier 134b stores an identifier for identifying a case executed by software corresponding to the design information. The execution environment 134c stores an execution environments of the corresponding case. The operation start date 134d stores a date when an operation of the corresponding case is started. The operation state 134e stores an operation state of the corresponding case. The maintenance record 134f stores a maintenance record of the corresponding case. The failure record 134g stores a failure record of the corresponding case.

The synonym list 135 is a list in which synonyms that are words or expressions having substantially the same meaning are collected.

### Overview

The overview of the invention will be described. The business process is a sequence of a plurality of works for achieving a specific object or a business target, and can be expressed by the plurality of works, contents of the works, a structure of the plurality of works (a flow of the works), or the like. The works are elements forming the business process. The business process is managed by the business process table 131, the work table 132, the design information table 133, the result information table 134, and the business process model information group 151. In the following description, for convenience, a set of information related to one business process included in the information (tables) may be referred to as “business process data”. A plurality of pieces of business process data stored in the business process management device 100 may be referred to as “accumulated business process data group”. The accumulated business process data group includes, for each of the plurality of business processes accumulated in the business process management device 100, the business process information (the business process table 131) for describing a content of the business process, the work information (the work table 132) for describing contents of the works forming the business process, and the data related to the business process (the design information table 133 and the business process model information group 151).

When the user constructs a new business process, the business process management device 100 is used. The business process management device 100 acquires new business process work information related to the new business process and current business process data related to a current business process. The new business process work information includes: new business process information including a name, an object, and a business process description of the new business process; and new work information including a name, an object, and a work description of the work that forms the new business process. The current business process data includes current business process work information related to a current business process and a work forming the current business process, and data related to the current business process. The current business process work information includes: current business process information including a name, an object, and a business process description of the current business process; and current work information including a name, an object, and a work description of the work that forms the current business process.

The business process management device 100 compares the new business process with the current business process by using the new work information and the current work information, and identifies one or more works which are insufficient for the current business process (hereinafter, referred to as an “insufficient work”) among the plurality of works forming the new business process.

The business process management device 100 searches the plurality of pieces of business process data (the accumulated business process data group) held (stored) in the auxiliary storage device 150 for a business process (hereinafter, referred to as a “similar business process”) where the new business process matches (high possibility of matching) a project environment. The business process management device 100 uses a keywords (may be referred to as a “first keyword”) extracted from the name, the object, and the business process description related to the current business process, and a keyword (may be referred to as a “second keyword”) extracted from the name, the object, and the business process description related to the new business process, to search for, from the accumulated business process data group, a business process including keywords which are same as or keywords which are regarded as being same as the first keyword and second keyword in the name, the object, and the business process description related to the business process, as candidates for a similar business process (similar business process candidates) where the new business process matches the project environment.

The business process management device 100 searches for, from a plurality of similar business process candidates found as a search result, the similar business process candidates in which at least one work corresponding to the identified insufficient work is included.

When there is no similar business process candidate in which at least one work corresponding to the identified insufficient work is included in the plurality of similar business process candidates found as the search result, the business process management device 100 identifies all the insufficient works as new development targets.

When there is one identified similar business process candidate, the business process management device 100 selects the one similar business process candidate as a reuse target similar business process. When there are a plurality of identified similar business process candidates, the business process management device 100 selects one of the plurality of identified similar business process candidates as the reuse target similar business process based on a predetermined selection criterion. In the example, the predetermined selection criterion includes the largest works corresponding to the insufficient works.

The business process management device 100 evaluates whether the work corresponding to the insufficient work among the plurality of works forming the reuse target similar business process can be actually used (applied) to the insufficient work of the new business process. According to the evaluation result, the business process management device 100 identifies the work that can be used to the insufficient work from the works corresponding to the insufficient works that forms the reuse target similar business process.

As described above, when the user constructs a new business process (for example, a new business process obtained by improving the current business process based on the current business process), the business process management device 100 can identify a business process where the new business process matches the project environment from the business processes accumulated in the business process management device 100, and can identify a work that can be reused from the identified business process for the insufficient work that is not in the current business process the plurality of works that form the new business process. Accordingly, the business process management device 100 can support the user to construct (generate) a new business process by effectively utilizing the current business process and the accumulated business process in a work unit.

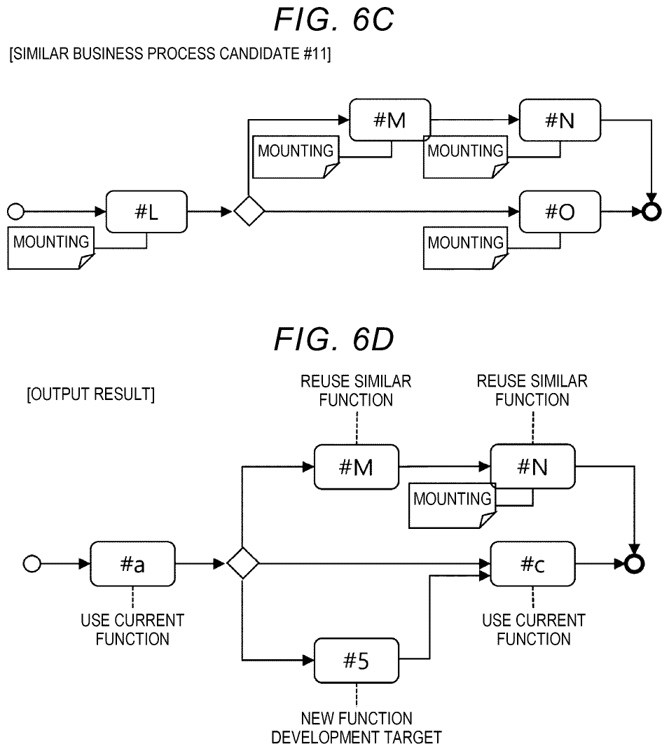

A specific example of usage of the business process management device 100 will be described with reference to FIGS. 6A to 6D. A new business process #1 shown in FIG. 6A is implemented by a work #1, a work #2, a work #3, a work #4, and a work #5 which are linked and executed continuously. After executing the work #1, the new business process #1 branches into three of the work #2, the work #4, and the work #5. When the new business process #1 proceeds to the work #2, after executing the work #2, the new business process #1 proceeds to the work #3, and after executing the work #3, the business process ends. When the new business process #1 proceeds to the work #4, after executing the work #4, the business process ends. When the new business process #1 proceeds to the work #5, after executing the work #5, the new business process #1 proceeds to the work #4, and after executing the work #4, the business process ends.

A current business process #2 shown in FIG. 6B is implemented by a work #a and a work #c which are linked and executed continuously. After executing the work #a, the current business process #2 proceeds to the work #c, and after executing the work #c, the business process ends. Comparing the new business process #1 with the current business process #2, the work #2, the work #3, and the work #5 of the new business process #1 are insufficient for the current business process #2.

The case where the business process management device 100 is applied to the new business process #1 and the current business process #2 will be described.

The business process management device 100 acquires new business process work information on the new business process #1 in FIG. 6A and current business process data of the current business process #2 in FIG. 6B. The business process management device 100 operates as described above to identify the work #2, the work #3, and the work #5 of the new business process #1 as insufficient works of the new business process #1.

As a search result, the business process management device 100 finds a similar business process candidate #11 (in this example, only one similar business process candidate is found) in FIG. 6C as a similar business process candidate, and identifies similar business process candidate #11 as a reuse target similar business process #11.

The business process management device 100 compares whether a work matching the identified insufficient work (the work #2, the work #3, and the work #5) is present in the reuse target similar business process #11. In this case, a work #M and a work #N which match the work #2 and the work #3 are present in the reuse target similar business process #11. The business process management device 100 evaluates whether the work #M and the work #N can be actually reused, and then identifies the work #2 and the work #3 as reuse portions. Since the work #5 among the insufficient works is not present in the similar business process #11, the business process management device 100 identifies the work #5 as a development target.

The business process management device 100 outputs information indicating a new business process as shown in FIG. 6D reflecting the identified work. The new business process indicated by the information is implemented by the work #a, the work #M, the work #N, the work #c, and the work #5 which are linked and executed continuously. The new business process indicated by the information branches into the work #M, the work #c, and the work #5 after the work #a. When the business process proceeds to the work #M, after executing the work #M, the business process proceeds to the work #N, and after executing the work #N, the business process ends. When the new business process indicated by the information proceeds to the work #c, after executing the work #c, the business process ends. When the new business process indicated by the information proceeds to the work #5, after executing the work #5, the new business process proceeds to the work #c, and after executing the work #c, the business process ends. In the new business process indicated by the information, the work #a uses a current function, the work #M and the work #N reuse the work of the similar business process, the work #c uses the current function, and the work #5 becomes a development target of a new function. The information indicating the new business process includes information indicating that the work #a is a work using the current function, the work #M and the work #N are works reusing the work of the similar business process, the work #c is a work using the current function, and the work #5 is a work which is a new function development target.

The business process management device 100 outputs such information to the first peripheral device 161 and/or the second peripheral device 171, and displays the information on, for example, the display. By confirming the information displayed on the display, the user can know the reusable work, the work as the new function development target, and the work that can use the current function. Accordingly, the business process management device 100 can support the user to construct a new business process (for example, a new business process obtained by improving the current business process) by effectively using the business process accumulated in the business process management device 100 so far.

### Specific Operation

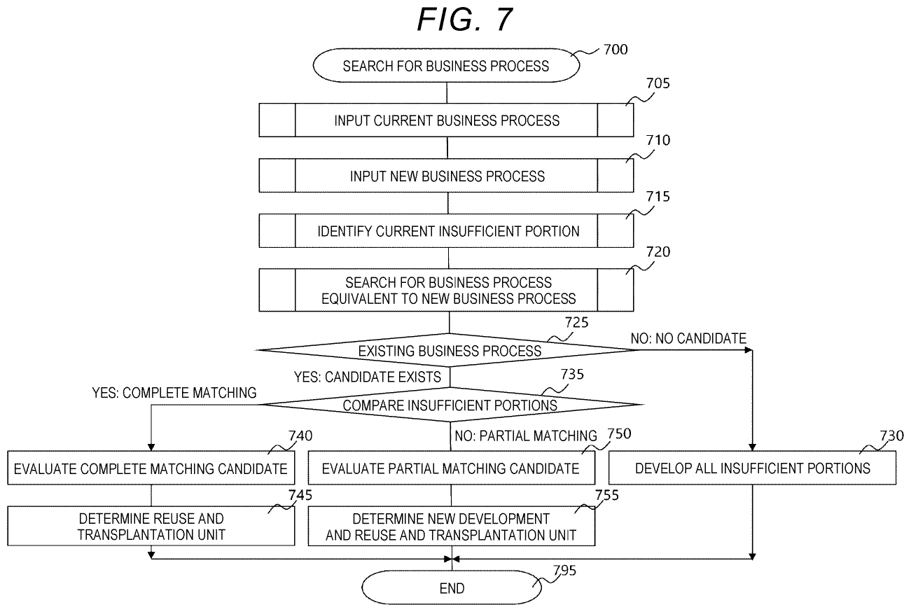

FIG. 7 is a flowchart showing a processing flow executed by the business process search and evaluation unit 123. The business process search and evaluation unit 123 starts processing from step 700, executes the processing of step 705 to step 720 described below in this order, and then proceeds to step 725.

Step 705: The business process search and evaluation unit 123 acquires the current business process data by the current business process input unit 127, and stores the current business process data in the business process table 131, the work table 132, the design information table 133, and the business process model information group 151. Details of this processing will be described later.

Step 710: The business process search and evaluation unit 123 acquires information related to the new business process by the new business process input unit 128, and stores the information in the business process table 131, the work table 132, the design information table 133, and the business process model information group 151. Details of this processing will be described later.

Step 715: The business process search and evaluation unit 123 identifies an insufficient portion (insufficient work) of the new business process, which is not in the current business process, among the works of the new business process. Details of this processing will be described later.

Step 720: The business process search and evaluation unit 123 searches for a candidate of a business process equivalent to the new business process (that is, a similar business process candidate), and selects an existing business process (that is, a reuse target similar business process). Details of this processing will be described later.

When the processing proceeds to step 725, the business process search and evaluation unit 123 determines whether the reuse target similar business process (the existing business process) is present as a search result of step 720.

When the reuse target similar business process (the existing business process) is not present, the business process search and evaluation unit 123 determines “NO” in step 725 and proceeds to step 730, evaluates all of the insufficient portions (the insufficient works) of the new business process as development targets, identifies the works as the development targets, and proceeds to step 795 to temporarily end the processing flow.

When the reuse target similar business process (the existing business process) is present, the business process search and evaluation unit 123 determines “YES” in step 725 and proceeds to step 735, and compares matching portions between the insufficient portions (the insufficient works) identified in step 715 and the works forming the reuse target similar business process.

When all of the works of the insufficient portions identified in step 715 are present in the reuse target similar business process, the business process search and evaluation unit 123 determines “YES” in step 735, executes the processing of step 740 and step 745 described below in this order, and then proceeds to step 795 to temporarily end the processing flow.

Step 740: The business process search and evaluation unit 123 evaluates complete matching work candidates (that is, all the works of the insufficient portions).

Specifically, the business process search and evaluation unit 123 evaluates whether a work corresponding to an insufficient work can be actually reused among the works forming the reuse target similar business process. This evaluation is performed by, for example, evaluating whether software to be applied to the work can be applied to a system using the new business process. This evaluation may be performed based on the input evaluation obtained by the user operating the first peripheral device 161 or the second peripheral device 171.

Step 745: The business process search and evaluation unit 123 determines a reuse and transplantation unit based on an evaluation result of the work candidates. Specifically, when it is evaluated that the work can be actually reused in step 740, the business process search and evaluation unit 123 identifies the evaluated work as a reuse target work (a work to be reused (transplanted)), and identifies the other works as new development target works. The works other than the insufficient works in the new business process are identified as works using the current business process.

When a part of the works of the insufficient portions identified in step 715 is present in the reuse target similar business process, the business process search and evaluation unit 123 determines “NO” in step 735, executes the processing of step 750 and step 755 described below in this order, and then proceeds to step 795 to temporarily end the processing flow.

Step 750: The business process search and evaluation unit 123 evaluates partial matching work candidates (that is, a part of the works of the insufficient portions). Specifically, the business process search and evaluation unit 123 evaluates whether a work corresponding to a part of an insufficient work can be actually reused among the works forming the reuse target similar business process.

Step 755: The business process search and evaluation unit 123 determines development and the reuse and transplantation unit based on the evaluation result. Specifically, when a work that is evaluated as being actually reusable in step 750 is present, the business process search and evaluation unit 123 identifies the evaluated work as the reuse target work, and identifies the other works as new development target works. The works other than a part of the insufficient works are identified as the new development target works. The works other than the insufficient works in the new business process are identified as works using the current business process.

By executing the above processing flow, the business process search and evaluation unit 123 identifies, among the new business process, the reuse target works that are reusable, the new development target works, and the works using the current business process. The business process search and evaluation unit 123 outputs, to the first peripheral device 161 and/or the second peripheral device 171, the new business process information (for example, the information as shown in FIG. 6D) based on the identified information.

### Step 705

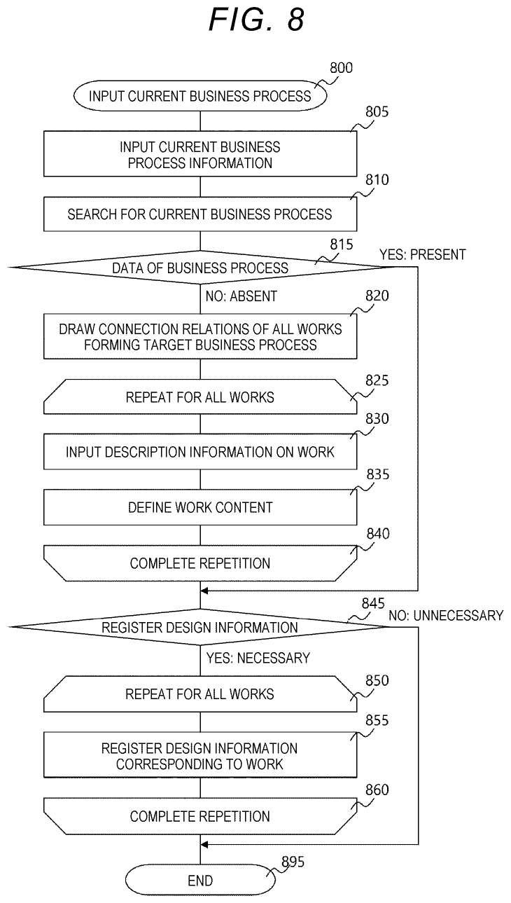

FIG. 8 is a flowchart showing a processing flow executed by the current business process input unit 127. When the current business process input unit 127 proceeds to step 705 of FIG. 7, the current business process input unit 127 starts processing from step 800 of FIG. 8, executes the processing of step 805 and step 810 described below in this order, and then proceeds to step 815.

Step 805: The current business process information (the name, the object, and the business process description of the current business process) is input to the current business process input unit 127.

Step 810: The current business process input unit 127 searches for the business process corresponding to the current business process information by referring to the business process table 131 based on the input information.

The current business process input unit 127 proceeds to step 815, and determines whether the business process corresponding to the current business process information is found as a search result.

As the search result, when the business process corresponding to the current business process information is found, the current business process input unit 127 determines “YES” in step 815 and proceeds to step 845.

As the search result, when no business process corresponding to the current business process information is found, the current business process input unit 127 determines “NO” in step 815 and proceeds to step 820.

When the current business process input unit 127 proceeds to step 820, information (business process model), in which connection relations of all works forming a target business process are drawn, is input to the current business process input unit 127. The business process model is generated and input by, for example, operating a GUI screen displayed on the first peripheral device 161 (user terminal) by the user. The current business process input unit 127 assigns a model information identifier to the input business process model, and stores the model information identifier in the business process model information group 151 via the business process registration unit 121.

Next, the current business process input unit 127 executes loop processing of step 825 to step 840. That is, the current business process input unit 127 repeatedly performs the processing of step 830 and step 835 described below until the processing for all the works forming the current business process is completed.

Step 830: When description information on a work is input to the current business process input unit 127, the current business process input unit 127 assigns an identifier to the work, associates the input description information with the identifier of the work, and registers (stores) the input description information in the work table 132 via the business process registration unit 121.

Step 835: When a definition (a name and an object) of a work content is input to the current business process input unit 127, the current business process input unit 127 associates the input definition (the name and the object) with the identifier of the work, and registers (stores) the input definition in the work table 132 via the business process registration unit 121.

After executing the loop processing of step 825 to step 840, the current business process input unit 127 proceeds to step 845.

When the current business process input unit 127 proceeds to step 845, the current business process input unit 127 determines whether registration of the design information is necessary for the current business process. This determination is made based on, for example, an instruction input by the user via the first peripheral device 161.

When the registration of the design information is not necessary for the current business process, the current business process input unit 127 determines “NO” in step 845, and proceeds to step 895 to temporarily end the processing flow.

When the registration of the design information is necessary for the current business process, the current business process input unit 127 determines “YES” in step 845, and executes the loop processing of step 850 to step 860. That is, the current business process input unit 127 repeatedly performs the processing of step 855 described below until the processing for all the works forming the current business process is completed.

Step 855: When design information corresponding to the work is input to the current business process input unit 127, the current business process input unit 127 assigns an identifier such as an identifier of the design information, associates the input design information with the identifier, and registers (stores) the input design information in the design information table 133 via the design information registration unit 124.

After executing the loop processing of step 850 to step 860, the current business process input unit 127 proceeds to step 895 to temporarily end the processing flow, and proceeds to step 710 of FIG. 7.

### Step 710

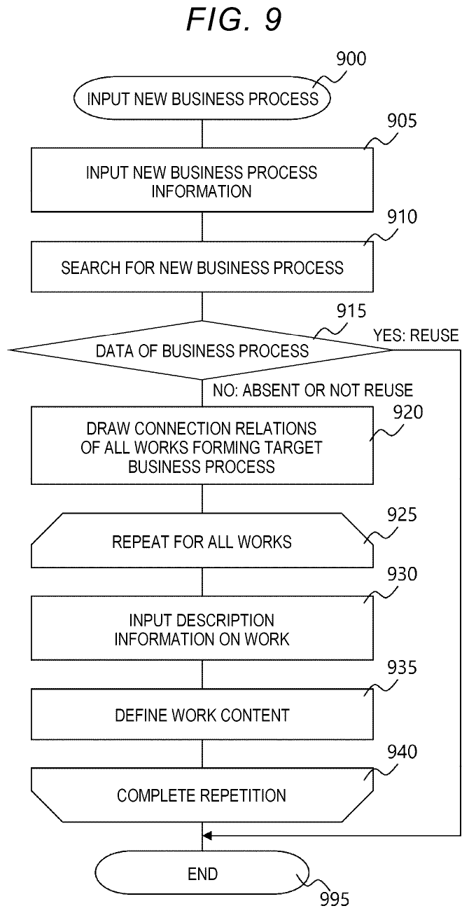

FIG. 9 is a flowchart showing a processing flow executed by the new business process input unit 128. When the new business process input unit 128 proceeds to step 710 of FIG. 7, the new business process input unit 128 starts processing from step 900 of FIG. 9, executes the processing of step 905 and step 910 described below in this order, and then proceeds to step 915.

Step 905: The new business process information (the name, the object, and the business process description of the new business process) is input to the new business process input unit 128.

Step 910: The new business process input unit 128 searches for the business process corresponding to the new business process information by referring to the business process table 131 based on the input information.

The new business process input unit 128 proceeds to step 915, and determines whether the business process corresponding to the new business process information is found as a search result.

As the search result, when the business process corresponding to the new business process information is found, the new business process input unit 128 determines “YES” in step 915, proceeds to step 995 to temporarily end the processing flow, and then proceeds to step 715 of FIG. 7. In this case, the found business process is identified as a target to be reused in the new business process, and the processing ends.

As the search result, when no new business process corresponding to the new business process information is found, the new business process input unit 128 determines “NO” in step 915 and proceeds to step 920.

When the new business process input unit 128 proceeds to step 920, information (business process model), in which connection relations of all works forming a target business process are drawn, is input to the new business process input unit 128. The business process model is generated and input by, for example, operating a GUI screen displayed on the second peripheral device 171 (user terminal) by the user. The new business process input unit 128 assigns a model information identifier to the input business process model, and stores the model information identifier in the business process model information group 151 via the business process registration unit 121.

Next, the new business process input unit 128 executes loop processing of step 925 to step 940. That is, the new business process input unit 128 repeatedly performs the processing of step 930 and step 935 described below until the processing for all the works forming the new business process is completed.

Step 930: When description information on a work is input to the new business process input unit 128, the new business process input unit 128 assigns an identifier to the work, associates the input description information with the identifier of the work, and registers (stores) the input description information in the work table 132 via the business process registration unit 121.

Step 935: When a definition (a name and an object) of a work content is input to the new business process input unit 128, the new business process input unit 128 associates the input definition (the name and the object) with the identifier of the work, and registers (stores) the input definition in the work table 132 via the business process registration unit 121.

After executing the loop processing of step 925 to step 940, the new business process input unit 128 proceeds to step 995 to temporarily end the processing flow, and then proceeds to step 715 of FIG. 7.

### Step 715

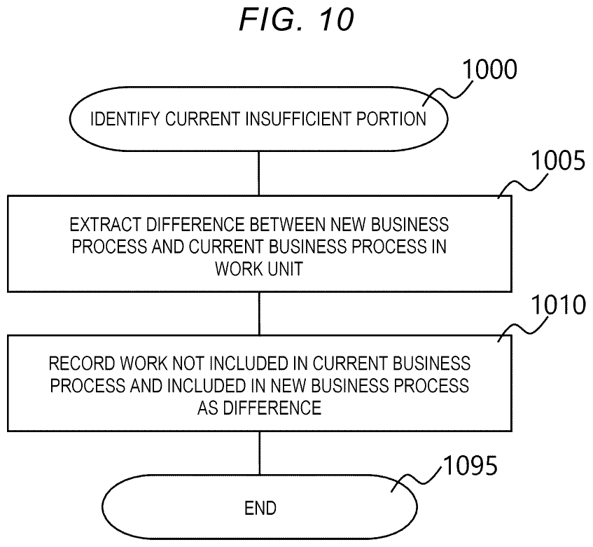

FIG. 10 is a flowchart showing a processing flow executed by the business process search and evaluation unit 123. When the business process search and evaluation unit 123 proceeds to step 720, the business process search and evaluation unit 123 starts processing from step 1000 of FIG. 10, executes the processing of step 1005 and step 1010 described below in this order, proceeds to step 1095 to temporarily end the processing flow, and then proceeds to step 720 of FIG. 7.

Step 1005: The business process search and evaluation unit 123 extracts a difference between the new business process and the current business process in a work unit using the new work information and the current work information.

Step 1010: The business process search and evaluation unit 123 records, in the memory 110, a work not included in the current business process and included in the new business process as a difference (that is, an insufficient work).

### Step 720

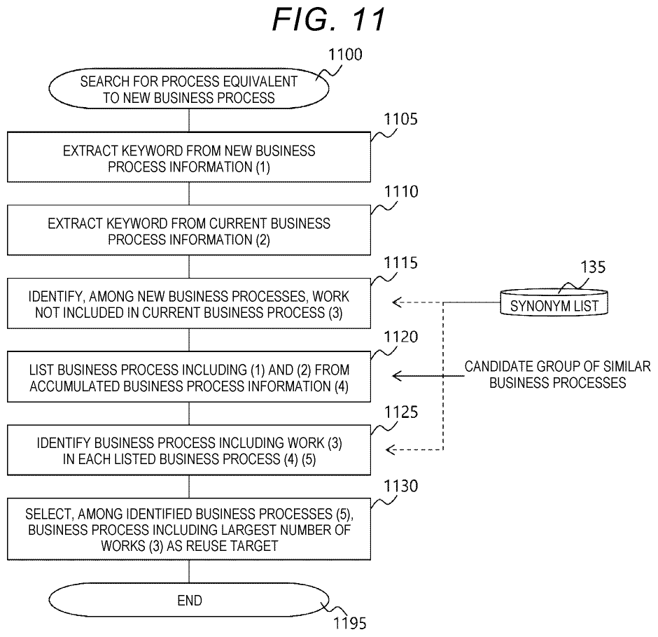

FIG. 11 is a flowchart showing a processing flow executed by the business process search and evaluation unit 123. When the business process search and evaluation unit 123 proceeds to step 720, the business process search and evaluation unit 123 starts processing from step 1100 of FIG. 11, executes the processing of step 1105 to step 1130 described below in this order, proceeds to step 1195 to temporarily end the processing flow, and then proceeds to step 725 of FIG. 7.

Step 1105: The business process search and evaluation unit 123 extracts a keyword from the new business process information. Here, as the extracted keyword, a keyword related to the project environment (for example, a keyword related to a business type, a business category, a project scale, an investment amount, or the like) may be extracted from the name, the object, and the business process description of the new business process.

Step 1110: The business process search and evaluation unit 123 extracts a keyword from the current business process information. Here, as the extracted keyword, a keyword related to the project environment (for example, a keyword related to a business type, a business category, a project scale, an investment amount, or the like) may be extracted from the name, the object, and the business process description.

Step 1115: The business process search and evaluation unit 123 identifies a work which is not in the current business process (that is, an insufficient work) among the new business process using the new work information and the current work information. In this processing, the difference recorded in the memory 110 in step 1010 of FIG. 10 may be identified as the insufficient work. The insufficient work identification is performed in a work unit, and is performed by identifying, as the insufficient work, a work in which a keyword (extracted keyword) of the new work information is same as or is regarded as being same as a keyword (extracted keyword) of the current work information and which is not present in the current business process, among the works forming the new business process. “The keywords are the same” means that the compared keywords include completely the same phrase, and “the keywords are regarded as the same” means that the compared words are regarded as the same word in the synonym list 135. The synonym list 135 stores information indicating keywords that may be regarded as the same.

Step 1120: The business process search and evaluation unit 123 searches the business process table 131 for a business process including the keyword extracted in step 1105 and the keyword that is same as or is regarded as being same as the keyword extracted in step 1110, and lists the found one or more business processes (that is, similar business process candidates).

Step 1125: The business process search and evaluation unit 123 identifies, among the listed similar business process candidates, one or more business processes (similar business process candidates) including a work corresponding to the identified insufficient work. Whether the work corresponding to the identified insufficient work is included in the similar business process candidate is performed by comparing whether the keyword of the current work information and the keyword of the new work information are the same or are regarded as the same for the works to be compared in a work unit. When the keywords are the same or are regarded as the same, it is determined that the work corresponding to the identified insufficient work is included in the similar business process candidate. When the keywords are not the same or are not regarded as the same, it is determined that the work corresponding to the identified insufficient work is not included in the similar business process candidate.

Step 1130: The business process search and evaluation unit 123 selects, among the plurality of business processes (similar business process candidates) identified in step 1125, a similar business process candidate including the largest number of works corresponding to the identified insufficient work, as the reuse target similar business process. When there is one identified similar business process candidate, the business process search and evaluation unit 123 selects the one business process as a reuse target business process.

### Effects

As described above, the business process management device 100 according to the first embodiment can identify a portion that can be reused in a work unit for the new business process, and effectively utilize the accumulated business process by supporting to construct the new business process by effectively utilizing the accumulated business process in a work unit.

### First Modification of First Embodiment

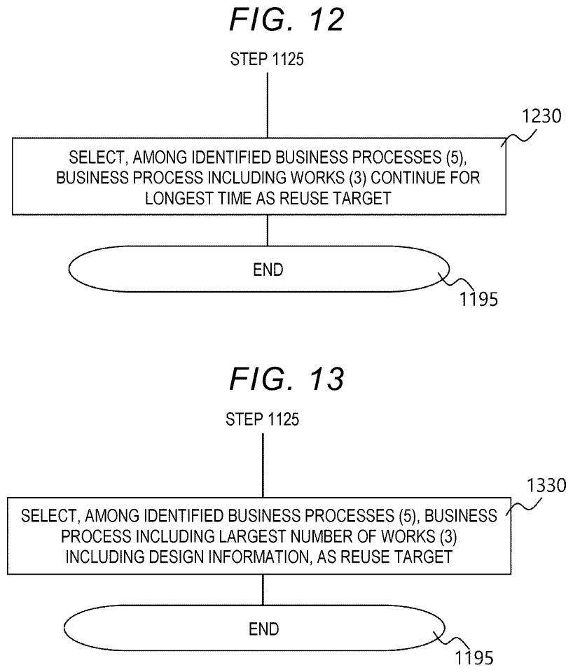

A first modification of the first embodiment may execute step 1230 of FIG. 12 instead of step 1130 of FIG. 11.

Step 1230: The business process search and evaluation unit 123 selects, among the plurality of identified similar business process candidates, a similar business process candidate in which works corresponding to the identified insufficient work continue for the longest time, as the reuse target similar business process.

In this case, in the first modification of the first embodiment, a similar business process candidate in which works corresponding to the insufficient work continue for a longer time can be selected as the reuse target similar business process.

### Second Modification of First Embodiment

A second modification of the first embodiment may execute step 1330 of FIG. 13 instead of step 1130 of FIG. 11.

Step 1330: The business process search and evaluation unit 123 uses the design information search and evaluation unit 126 to select, among the plurality of identified business processes, a business process corresponding to the identified insufficient work and including the largest number of works including the design information (the works associated with the design information in the design information table 133), as the reuse target business process.

In this case, in the second modification of the first embodiment, a similar business process candidate, in which the works corresponding to the insufficient work include more design information, can be selected as the reuse target similar business process.

### Third Modification of First Embodiment

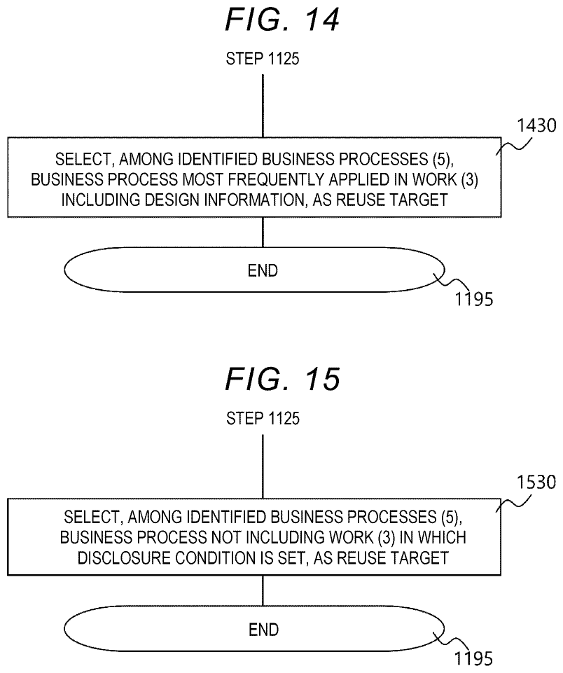

A third modification of the first embodiment may execute step 1430 of FIG. 14 instead of step 1130 of FIG. 11.

Step 1430: The business process search and evaluation unit 123 uses the design information search and evaluation unit 126 to select, among the plurality of identified business processes, a similar business process candidate, which corresponds to the identified insufficient work and includes the design information and to which the design information is most frequently applied (a similar business process candidate applied to a case including the largest number of design information in the result information table 134), as the reuse target business process.

In the third modification of the first embodiment, a similar business process candidate, in which an application result of the design information on the work corresponding to the insufficient work is larger, can be selected as the reuse target similar business process.

### Fourth Modification of First Embodiment

In a fourth modification of the first embodiment, a column for setting a disclosure condition may be added to the work table 132. In this column, information indicating a disclosure condition (disclosure restriction) that can be disclosed in only a specific area is stored.

The fourth modification of the first embodiment may execute step 1530 of FIG. 15 instead of step 1130 of FIG. 11.

Step 1530: The business process search and evaluation unit 123 selects, among the plurality of identified business processes, a similar business process candidate corresponding to the identified insufficient work and not including a work in which the disclosure condition (disclosure restriction) is set, as the reuse target business process.

In the fourth modification of the first embodiment, a similar business process candidate without the disclosure condition (disclosure restriction) can be selected as the reuse target similar business process.

### Second Embodiment

The business process management device 100 according to a second embodiment of the invention will be described. The business process management device 100 according to the second embodiment differs from the business process management device 100 according to the first embodiment only in the following points.

The business process management device 100 according to the second embodiment receives current business process data related to a current business process, information indicating a project environment, and information indicating a provision value (hereinafter, the pieces of information may be referred to as “project environment provision value information”), finds a reuse target similar business process, which is similar to the current business process in consideration of the project environment provision value information, from business processes accumulated in the business process management device 100, and identifies the reuse target similar business process as a reuse target.

Hereinafter, the difference point will be mainly described.

### Specific Operation

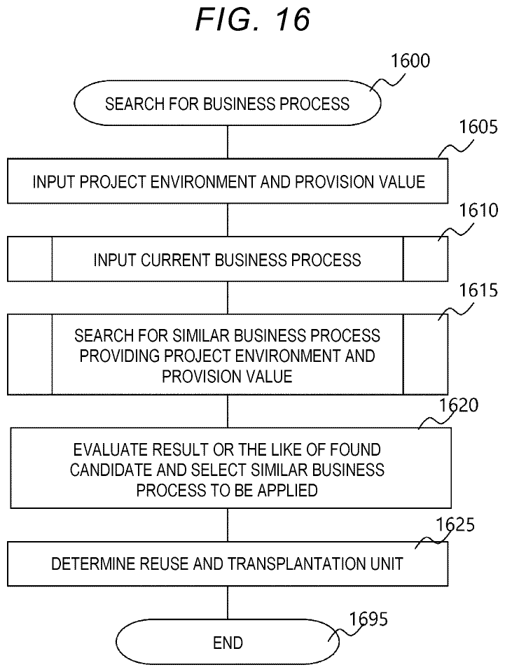

FIG. 16 is a flowchart showing a processing flow executed by the business process search and evaluation unit 123. The business process search and evaluation unit 123 starts processing from step 1600, executes the processing of step 1605 to step 1625 described below in this order, and then proceeds to step 1695.

Step 1605: The business process search and evaluation unit 123 acquires the information indicating the project environment and the provision value (the project environment provision value information) by a project environment and provision value input unit (not shown), and stores the information in the memory 110. The project environment provision value information is information in which the project environment and the provision value of the business process is expressed by a sentence, a word, a word combination, or the like.

Step 1610: The business process search and evaluation unit 123 acquires the current business process data by the current business process input unit 127. Details of this processing are the same as those of the above-described processing flow of FIG. 8.

Step 1615: The business process search and evaluation unit 123 searches for a similar business process that provides the acquired project environment provision value information indicating the project environment and the provision value. Details of this processing will be described later.

Step 1620: The business process search and evaluation unit 123 evaluates a result or the like of a found similar business process candidate, and selects a reuse target similar business process. That is, the business process search and evaluation unit 123 identifies all works forming the reuse target similar business process as a reuse target work candidate by selecting the reuse target similar business process.

Step 1625: The business process search and evaluation unit 123 evaluates, in a work unit, whether works forming the selected reuse target similar business process can be actually reused and transplanted, and then determines a reuse and transplantation unit.

### Step 1615

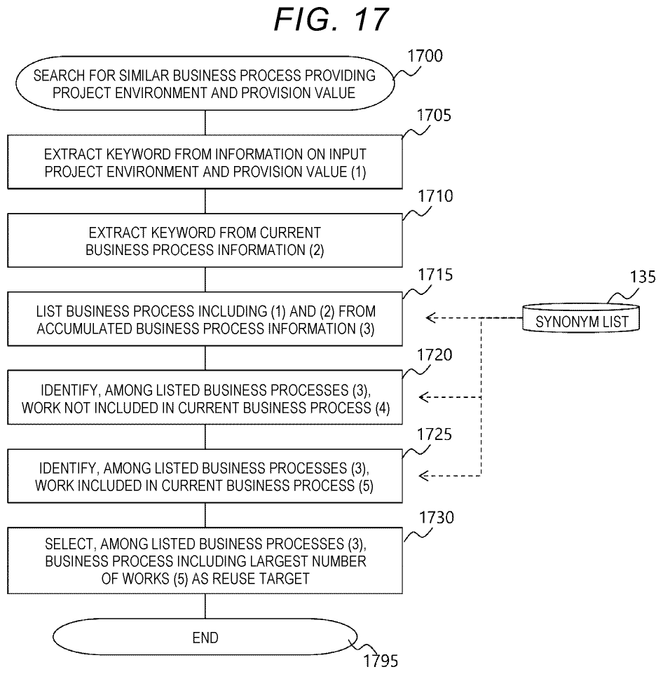

FIG. 17 is a flowchart showing a processing flow executed by the business process search and evaluation unit 123. When the business process search and evaluation unit 123 proceeds to step 1615 of FIG. 16, the business process search and evaluation unit 123 starts processing from step 1700, executes the processing of step 1705 to step 1730 described below in this order, proceeds to step 1795 to end the processing flow, and then proceeds to step 1620 of FIG. 16.

Step 1705: The business process search and evaluation unit 123 extracts a keyword from the information indicating the input project environment and provision value. Here, for the keyword, a keyword related to the project environment and the provision value is extracted from sentences (or words or word combinations) stored in the information indicating the project environment and the provision value (the project environment provision value information).

Step 1710: The business process search and evaluation unit 123 extracts a keyword from current business process information.

Step 1715: The business process search and evaluation unit 123 searches the business process table 131 for a business process including the keyword extracted in step 1705 and the keyword that is same as or is regarded as being same as the keyword extracted in step 1710, and lists the found one or more business processes (that is, similar business process candidates).

Step 1720: The business process search and evaluation unit 123 identifies, among the listed similar business process candidates, a work that is not in the current business process. The processing of step 1720 may be omitted.

Step 1725: The business process search and evaluation unit 123 identifies, for the listed similar business process candidates, a work corresponding to the work included in the current business process.

Step 1730: The business process search and evaluation unit 123 selects, among the plurality of listed business processes, a similar business process candidate including the largest number of works identified in step 1725 as the reuse target similar business process.

### Effects

As described above, the business process management device 100 according to the second embodiment can identify, in a work unit, works that form a business process similar to the current business process in consideration of the information indicating the project environment input by the user and the provision value, as a reuse target, and effectively utilize the accumulated business process by supporting to construct a new business process by effectively utilizing the accumulated business process in a work unit.

### First Modification of Second Embodiment

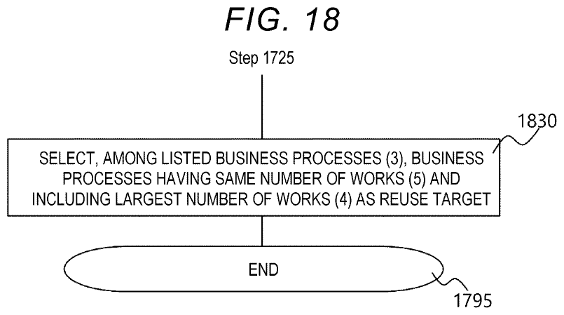

A first modification of the second embodiment may execute step 1830 of FIG. 18 instead of step 1730 of FIG. 17.

Step 1830: The business process search and evaluation unit 123 selects, when there are a plurality of similar business process candidates including the largest number of works identified in step 1725 (similar business process candidates having the same number of identified works) among the plurality of listed similar business process candidates, the business process including the largest number of works identified in step 1720 as a reuse target business process.

### Other Modifications

The invention is not limited to the embodiments and modifications described above, and various modifications can be adopted within the scope of the invention. Further, the embodiments and modifications described above can be combined with one another without departing from the scope of the invention.

In each of the embodiments described above, the identification of the insufficient works of the new business process in step 715 of FIG. 7 (the works that are not in the current business process among the works of the new business process) may be performed based on the operation of the first peripheral device 161 by the user.

What is claimed is:

1. A business process management device comprising:
an information processing device configured to manage a business process including a sequence of a plurality of works, wherein
the information processing device includes a storage device that stores, for each of a plurality of business processes, an accumulated business process data group including business process information for describing a content of the business process, work information for describing a content of a work forming the business process, and data related to the business process, and
the information processing device
acquires current business process data, which includes current business process work information related to a current business process and a work forming the current business process and data related to the current business process, and new business process work information related to a new business process and a work forming the new business process, or project environment provision value information indicating a project environment and a provision value, and
performs, based on the current business process work information and the new business process work information or the project environment provision value information,
similar business process candidate identification of identifying, from the accumulated business process data group, one or more similar business process candidates which are the business process where the current business process and the new business process or the project environment provision value information match the project environment,
reuse target similar business process selection of selecting a reuse target similar business process from the identified one or more similar business process candidates, and
reuse target work identification of identifying, in a work unit, at least a part of works of the selected reuse target similar business process as a reuse target.

2. The business process management device according to claim 1, wherein
the business process information includes a name, an object, and a business process description of the business process, and the work information includes a name, an object, and a work description of a work forming the business process, and
the information processing device
acquires, as the current business process work information, current business process information including a name, an object, and a business process description of the current business process and current work information including a name, an object, and a work description of the work forming the current business process, and
acquires, as the new business process work information, new business process information including a name, an object, and a business process description of the new business process and new work information including a name, an object, and a work description of the work forming the new business process.

3. The business process management device according to claim 2, wherein
the information processing device
acquires the current business process data and the new business process work information,
performs, based on the current business process information, the new business process information, and the business process information, the similar business process candidate identification of identifying, from the accumulated business process data group, the one or more similar business process candidates which are the business process where the current business process and the new business process match the project environment,
performs, based on the current work information and the new work information, the reuse target similar business process selection by performing insufficient work identification of identifying an insufficient work which is a work not present in the current business process among works forming the new business process, determining whether the work corresponding to the identified insufficient work is present for each of the identified one or more similar business process candidates, and selecting the reuse target similar business process from the identified one or more similar business process candidates based on a result of the determination, and
performs the reuse target work identification by performing reuse target candidate work identification of identifying, as a reuse target candidate work, a work which is applicable to the insufficient work of the new business process from the selected reuse target similar business process, evaluating whether the reuse target candidate work is actually reusable, and identifying the reuse target candidate work as a reuse target according to an evaluation result.

4. The business process management device according to claim 3, wherein
the storage device stores a synonym list,
the information processing device
performs similar business process candidate identification by identifying, as the similar business process candidate, the business process in which a keyword extracted from the current business process information and a keyword extracted from the new business process information are included in the business process information or regarded as being included in the business process information based on the synonym list, and
performs the insufficient work identification by determining whether there is a work in which a keyword extracted from the new work information is same as or is regarded as being same as a keyword extracted from the current work information in a work unit, and identifying, as the insufficient work, a work in which the keyword extracted from the new work information is same as or is regarded as being same as the keyword extracted from the current work information and which is not found, among the works forming the new business process.

5. The business process management device according to claim 3, wherein
the information processing device performs the reuse target similar business process selection by selecting, among the identified one or more similar business process candidates, the similar business process candidate including the largest number of works corresponding to the identified insufficient work, as the reuse target similar business process.

6. The business process management device according to claim 3, wherein
the information processing device performs the reuse target similar business process selection by selecting, among the identified one or more similar business process candidates, the similar business process candidate in which works corresponding to the identified insufficient work continue for the longest time, as the reuse target similar business process.

7. The business process management device according to claim 3, wherein
the storage device stores design information management information indicating design information associated with each of the works forming the business process, and
the information processing device
determines the number of works associated with the design information for the identified one or more similar business process candidates based on the design information management information, and
performs the reuse target similar business process selection by selecting, among the identified one or more similar business process candidates, the similar business process candidate corresponding to the identified insufficient work and including the largest number of works associated with the design information, as the reuse target similar business process.

8. The business process management device according to claim 3, wherein
the storage device stores design information management information indicating design information associated with each of the works forming the business process and result management information indicating a record related to a case to which the design information is applied, and
the information processing device
determines, based on the design information management information and the result management information, the number of works associated with the design information and the number of application results of the design information on the works to the business process, for the identified one or more similar business process candidates, and
performs the reuse target similar business process selection by selecting, among the identified one or more similar business process candidates, the similar business process candidate which corresponds to the identified insufficient work, is a work associated with the design information, and includes the largest number of application results of the works to the business process, as the reuse target similar business process.

9. The business process management device according to claim 3, wherein
the storage device stores a disclosure condition for a work, and
the information processing device performs the reuse target similar business process selection by selecting, among the identified one or more similar business process candidates, the similar business process candidate which corresponds to the identified insufficient work and includes the largest number of works for which a disclosure restriction is not set as the disclosure condition, as the reuse target similar business process.

10. The business process management device according to claim 3, wherein
the information processing device performs the reuse target work identification by evaluating whether the reuse target candidate work is actually reusable, and identifying the reuse target candidate work as a reuse target when it is evaluated that the reuse target candidate work is reusable.

11. The business process management device according to claim 2, wherein
the information processing device
acquires the current business process data and the project environment provision value information, and
performs, based on the current business process information and the project environment provision value information,
the similar business process candidate identification of identifying, from the accumulated business process data group, the one or more similar business process candidates which are the business process where the current business process and the project environment provision value information match the project environment,
performs the reuse target similar business process selection by identifying a work included in the current business process for each of the identified one or more similar business process candidates, and selecting the reuse target similar business process from the identified one or more similar business process candidates based on an identification result, and
performs reuse target candidate work identification of identifying all works of the reuse target similar business process as reuse target candidates by setting the selected reuse target similar business process as a reuse target, and performs the reuse target work identification by evaluating whether a reuse target candidate work is actually reusable and identifying the reuse target candidate work as a reuse target according to an evaluation result.

12. The business process management device according to claim 11, wherein
the information processing device performs the reuse target similar business process selection by identifying a work corresponding to the work included in the current business process for each of the identified one or more similar business process candidates, and selecting, as the reuse target similar business process, the similar business process candidate including the largest number of identified works among the identified one or more similar business process candidates.

13. The business process management device according to claim 11, wherein
the information processing device
identifies a work not included in the current business process in addition to identifying a work corresponding to the work included in the current business process for each of the identified one or more similar business process candidates,
when there is one similar business process candidate including the largest number of identified works, performs the reuse target similar business process selection by selecting, among the identified one or more similar business process candidates, the similar business process candidate including the largest number of works included in the identified current business process, as the reuse target similar business process, and
when there are a plurality of the similar business process candidates including the largest number of identified works, performs the reuse target similar business process selection by selecting, among the plurality of similar business process candidates including the largest number of identified works, the similar business process candidate including the largest number of works not included in the identified current business process, as the reuse target similar business process.

14. The business process management device according to claim 1, wherein
the information processing device outputs, to a peripheral device, information indicating a business process including information indicating the identified reuse target work.

15. A business process management method using an information processing device that manages a business process including a sequence of a plurality of works, the information processing device including a storage device that stores, for each of a plurality of business processes, an accumulated business process data group including business process information for describing a content of the business process, work information for describing a content of a work forming the business process, and data related to the business process, the business process management method comprising:
by the information processing device
acquiring current business process data, which includes current business process work information related to a current business process and a work forming the current business process and data related to the current business process, and new business process work information related to a new business process and a work forming the new business process, or project environment provision value information indicating a project environment and a provision value; and
performing, based on the current business process work information and the new business process work information or the project environment provision value information,
similar business process candidate identification of identifying, from the accumulated business process data group, one or more similar business process candidates which are the business process where the current business process and the new business process or the project environment provision value information match the project environment,
reuse target similar business process selection of selecting a reuse target similar business process from the identified one or more similar business process candidates, and
reuse target work identification of identifying, in a work unit, at least a part of works of the selected reuse target similar business process as a reuse target.
